(19) United States
(12) Patent Application Publication
(10) Pub. No.: US 2026/0275796 A1
(43) Pub. Date: Sep. 17, 2026

(54) DOOR ASSEMBLY FOR A VEHICLE DOOR

(71) Applicant: Brose Fahrzeugteile SE & Co. Kommanditgesellschaft, Bamberg, Bamberg (DE)

(72) Inventors: Christian DALLOS, Poruba (SK); Matthias HEPPNER, Burgkunstadt (DE); Jozef KALAJ, Handlová (SK); Michael KREILE, Itzgrund (DE); Jan MELLO, Prievidza (SK); Thomas SALHOFF, Hallstadt (DE)

(21) Appl. No.: 19/559,008

(22) Filed: Mar. 6, 2026

(30) Foreign Application Priority Data
Mar. 11, 2025 (DE) 202025101302.9

(51) Int. Cl. E05F 15/689

(52) U.S. Cl. CPC E05F 15/6909; E05Y 2201/668; E05Y 2201/684; E05Y 2600/46; E05Y 2600/51; E05Y 2600/632; E05Y 2900/55

(57) ABSTRACT

A door assembly for a vehicle door of a motor vehicle, having a door inner part and a guide rail with a bearing pin, and having an annular cable pulley for a pull cable of a window regulator assembly, wherein the cable pulley is snap fitted on the bearing pin in a rotatably mounted manner, and wherein the bearing pin has a receiving opening for a fastening element for screwing the guide rail to a structural part of the door inner part.

### CROSS-REFERENCE TO RELATED APPLICATION

This application claims priority pursuant to 35 U.S.C. 119(a) to German Patent Application No. 202025101302.9, filed March 11, 2025, which application is incorporated herein by reference in its entirety.

### FIELD OF THE INVENTION

The invention relates to a door assembly for a vehicle door of a motor vehicle, comprising a frame-like door inner part and comprising a guide rail, attached or attachable thereto, of a window regulator assembly.

### BACKGROUND

A vehicle door of a motor vehicle (motor vehicle door) typically has a generally frame-like door inner part, also referred to as a door shell, and a door outer panel forming the door outer skin, as well as, if applicable, a door inner panel or a door inner lining. The door inner part or door shell connected to the door outer panel typically has two spaced-apart, opposite lateral frame portions and a sill portion connecting them, as well as, if applicable, a lower frame portion.

The following is information regarding the spatial directions in a coordinate system of a motor vehicle (vehicle coordinate system) with respect to the typical position or location of a vehicle door (side door) of the motor vehicle in relation to its vehicle body. The abscissa axis (X-axis) here is oriented along the vehicle longitudinal direction, the ordinate axis (Y-axis) along the vehicle transverse direction, and the applicate axis (Z-axis) along the vehicle height.

The sill portion, oriented in the vehicle longitudinal direction (X direction in the vehicle coordinate system), together with the lateral frame portions oriented in the direction of the vehicle height (Z direction in the vehicle coordinate system) and with a frame portion connecting them at the underside of the door and running in the X direction, delimits a frame cutout in the door inner part (door shell). In the mounted state of the vehicle door, this frame cutout or module cutout is typically at least partially covered by a planar door module or is designed with a structured mounting region for functional components of the vehicle door.

A window regulator assembly, hereinafter also referred to as a window regulator for short, of a motor vehicle comprises a support component (support) as well as a guide device arranged thereon for guiding a flexible pulling means (pull cable), via which an adjusting torque (an adjusting force) generated at an (electromotive) actuator of a window regulator can be transmitted to a window pane to be adjusted. The support component on which the guide device is mounted is a structural part of the door inner part or a module support (door module support) which, together with the pre-mounted functional components, in particular the window regulator assembly or window regulator, is installed in the door assembly of the motor vehicle door.

The guide device has a single guide rail or two guide rails and several deflection elements, in particular in the form of rotatably mounted cable pulleys. By means of the deflection elements, the pull cable is deflected in the region of the rail ends of the relevant guide rail to the electromotive actuator of the window regulator, also referred to as a cable-driven window regulator. The pull cable is attached to at least one driver or rail slider which is slidingly guided on the associated guide rail along an adjustment path predefined by means of the guide device. The or each guide rail of the window regulator or window regulator assembly can be manufactured from a metal sheet material, for example as a stamped and bent part, or from plastics material, or can be integrated into the door module support.

Each cable pulley typically has a central bore through which the cable pulley is connected to the guide rail or to another supporting part of the (cable-driven) window regulator by means of an attachment element in the form of a rivet bolt (German Patent No. 198 55 011 C1) or a plug bolt or step bolt (German Patent No. 20 2008 010 920 U1). The attachment element allows the cable pulley to be screwed and/or pre-positioned in the (plastics) support component, for example. For this purpose, a step bolt with a bearing portion for the cable pulley and with a threaded portion for screwing to the support plate or to a structural element of the door inner part or to the guide rail can be used. Screw elements and clip elements with a widened head are known from German Patent No. 20 2005 017 112 U1 as securing and bearing elements for the cable pulley.

### SUMMARY

The invention is based on the object of specifying a door assembly with an advantageously mounted or mountable window regulator assembly and a suitably mounted cable pulley. Furthermore, a suitable guide rail and a door inner part for such a door assembly are to be specified.

Regarding the door assembly, the cited object is achieved according to the invention by the features of Claim 1, with respect to the guide rail by the features of Claim 9 and with regard to the door inner part by the features of Claim 10. Advantageous designs, developments and variants form the subject matter of the dependent claims.

The door assembly provided and configured for a vehicle door of a motor vehicle has a door inner part and a guide rail with a bearing pin and has an annular cable pulley for a pull cable of a window regulator. The cable pulley is latched or snap fitted on the bearing pin in a rotatably mounted manner. The bearing pin has a (central) receiving opening for a fastening element for joining the guide rail with a structural part, subsequently also referred to as a supporting structure or support, of the door inner part. The guide rail is preferably a plastics component with a molded-on bearing pin for the cable pulley. An actuator coupled to the cable pulley is suitably attached to the guide rail.

The fastening element is expediently a screw comprising a screw head and a threaded shank with a self-tapping or metric external thread. In one advantageous embodiment, a threaded sleeve, with a metric internal thread, is inserted into the receiving opening in the bearing pin. The threaded sleeve can be rotated or screwed into the bearing pin or be embedded therein by overmolding.

Alternatively, a self-tapping or self-cutting screw is screwed as a fastening element directly into the receiving opening in the bearing pin. Particularly preferably, in a pre-mounted state the fastening element is received in the receiving opening in the bearing pin before the guide rail is mounted on and fastened, attached by screw, to the door inner part.

According to a suitable design, the structural part has a joining opening. By means of a screw-head-like stop contour or bearing contour, the fastening element bears against this preferably keyhole-like joining opening when joining the guide rail to the door inner part. The structural part of the door inner part forms a support or a supporting structure for the guide rail, in particular in the region of at least one of the rail ends of the guide rail. The structural part, which can be an integral part of the door inner part or be a separate support component, is suitably a sheet part made of metal or plastics material.

The preferably keyhole-like joining opening for joining, advantageously screwing, the guide rail to the door inner part is provided in the region of this rail-end-side supporting structure. In the pre-mounted state with the cable pulley already placed on the bearing pin of the guide rail and latched thereto, and with the screw already received in the receiving opening in the bearing pin, said screw can be guided through via an opening region of the joining opening with a larger inner diameter than a screw head and then moved into an opening region, for example a slot-shaped opening region, with a reduced inner diameter of the joining opening and guided into an intended mounting position.

Suitably, the cable pulley has an annular pulley body that surrounds a central bearing opening. In particular, the cable pulley or the annular pulley body thereof has a ring inner wall enclosing the bearing opening, and a ring outer wall with a running groove or circumferential groove for the pull cable. Particularly preferably, the cable pulley has a number of circumferentially distributed latching tongues, and the bearing pin has an in particular encircling latching groove. The latching tongues latch or engage therein to produce the latching or snap-fit connection.

### BRIEF DESCRIPTION OF THE DRAWINGS

Exemplary embodiments of the invention are explained in more detail below with reference to the drawings, in which:

FIG. 1 is a top view of a door assembly with a door inner part (door shell) and with a guide rail, attached thereto or mountable thereon, of a window regulator assembly;

FIG. 2 is an enlarged section II from FIG. 1 with a cable pulley on a bearing pin of the guide rail;

FIG. 3 is a sectional view, along the line III-III in FIG. 2, of the guide rail, attached by screw to a structural part of the door inner part according to one variant, with a cable pulley latched (clipped) on the bearing pin;

FIG. 4 is an illustration according to Figure of a further variant of the screwing attachment of the guide rail to the structural part of the door inner part; and,

FIG. 5 is a sectional rear view of the screwing attachment to a keyhole-like joining opening in the structural part of the door inner part.

Parts and dimensions corresponding to one another are provided with the same reference signs in all figures.

### DETAILED DESCRIPTION OF THE INVENTION

The following is information given regarding the spatial directions in a vehicle coordinate system, in which the X-axis is oriented along the vehicle longitudinal direction, the Y-axis along the vehicle transverse direction, and the Z-axis along the vehicle height.

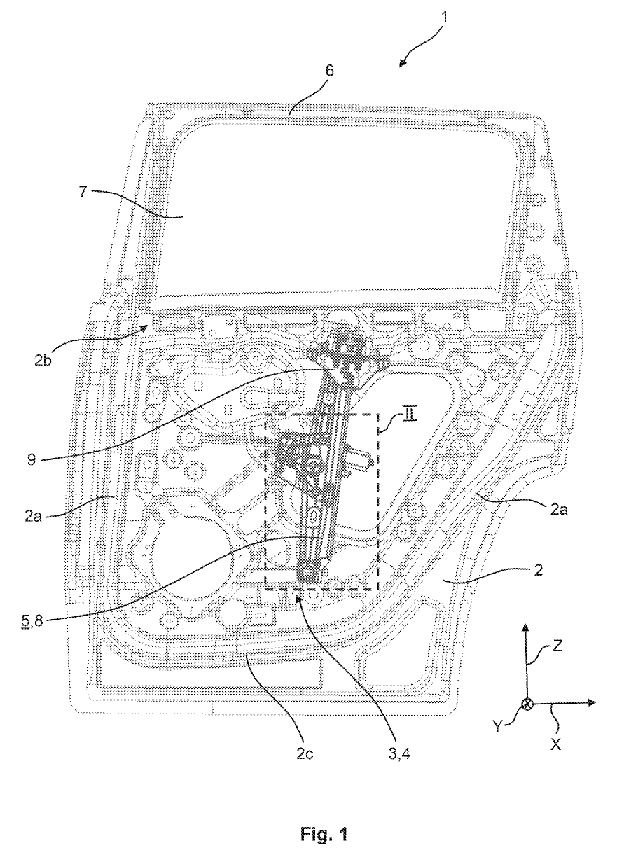

The door assembly 1 shown in FIG. 1 has a door inner part 2, also referred to as a door shell, with a mounting region 3 for functional components of a vehicle door of a motor vehicle. A structural part 4 is provided in the mounting region 3, which part is provided or configured and/or suitable as a support or supporting structure for a window regulator assembly 5. In the exemplary embodiment, the mounting region 3 or the structural part 4 is made of the material, in particular a sheet material or sheet metal, of the door inner part 2.

The mounting region 3 is delimited or bordered laterally by frame portions 2a spaced apart from each other in the X direction and oriented in the Z direction, on the upper side by an (upper) sill portion 2b running in the X direction, and on the lower side by a doorsill-side (lower) frame portion 2c, spaced apart from the sill portion 2b in the Z direction, of the door inner part 1.

In the exemplary embodiment, the door assembly 1 has a window frame 6, molded onto the door inner part 2, for a window pane (side pane) 7. The window pane 7 can be retracted into the door assembly 1 and thus into the mounting region 3 of the door inner part 2 via a sill slot, not described in any more detail, of the sill portion 2c, thus into an open position, and can be retracted from the mounting region 3 into a closed position in the window frame 6.

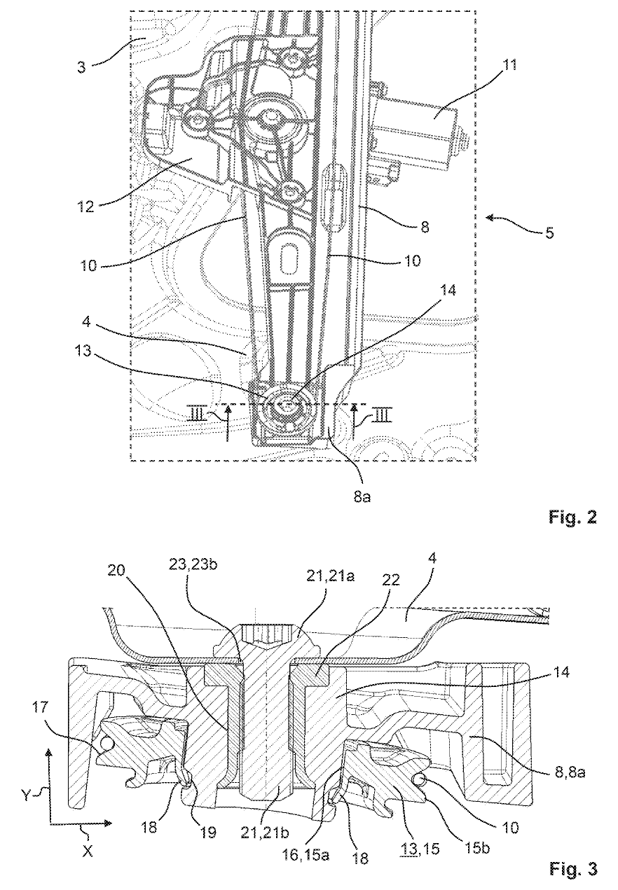

With reference also to FIG. 2, the window regulator assembly 5 has a guide rail 8 attached to the structural part 4 of the door inner part 2. A rail slider 9 coupled to the window pane 7 is slidingly guided on the guide rail 8. The rail slider 9 is coupled to an electromotive actuator 11 via a pull cable 10. The actuator 11 is mounted on a supporting structure 12 as an integral part of the guide rail 8.

The actuator 11 drives a cable drum, with the pull cable 10 wound thereon, in a manner not shown in more detail. The pull cable 10 is deflected via a lower cable pulley 13 and via an upper cable pulley, not shown, and guided on the rail slider 9. By means of the actuator 11 and the rail slider 9 coupled thereto via the pull cable 10, the window pane 7 can be moved between the open position and the closed position.

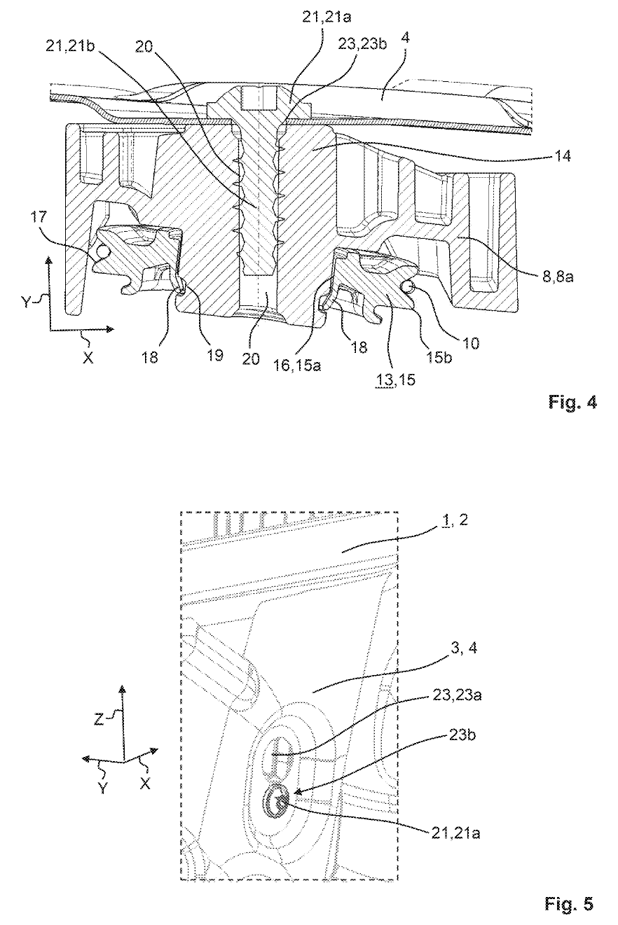

As can be seen relatively clearly from FIG. 3 and 4, the guide rail 8 has a bearing pin 14 on which the cable pulley 13 is rotatably mounted. The cable pulley 13 is attached to the bearing pin 14 in or by means of a latching or snap-fit connection. The guide rail 8 is a plastics component with a molded-on bearing pin 14.

The cable pulley 13 has an annular pulley body 15 that surrounds a central bearing opening 16. The cable pulley 13 or the annular pulley body 15 thereof has a ring inner wall 15a enclosing the bearing opening 16, and a ring outer wall 15b with a running groove 17 for the pull cable 10. The annular cable pulley 13 has several, preferably four to eight, in particular six, circumferentially distributed latching tongues 18. These are molded onto the ring inner wall 15a and are axially raised and directed radially inward. The bearing pin 14 has an encircling latching groove 19 in which the latching tongues 18 of the cable pulley 13 engage in the joining state to produce the latching or snap-fit connection.

The cable pulley 13 is expediently made of plastics material, in particular of a polymer or of polyamide (PA) or of polyoxymethylene (POM). The inner diameter of the central bearing opening 15 is at least two-thirds of the outer diameter of the cable pulley 13. When latched or snap fitted, the latching tongues 18 bear against the bearing pin 14 with sufficient pressing force and corresponding frictional force in such a way as to avoid undesirable wear of the locking tongues 18 or of the bearing pin 14 and resulting in running noises.

The bearing pin 14 has a (central) receiving opening 20 for a screw as a fastening element 21 for joining the guide rail to the structural part of the door inner part 2. The fastening element 21 is suitably a screw and has a screw head 21a and a threaded shank 21b with an external thread.

In the embodiment according to FIG. 3, the receiving opening 20 in the bearing pin 14 is designed as a receiving channel for a screw sleeve or threaded sleeve 22 as a metal part with a metric internal thread. The screw sleeve or threaded sleeve 22 is inserted into the bearing pin 14 and is over molded with the plastics material of the guide rail 8 and of the bearing pin 14. The external thread of the fastening element 21 or of the threaded shank 21b is a metric thread corresponding to the internal thread of the threaded sleeve 22. The fastening element 21 of this variant is therefore preferably a machine screw.

In the embodiment according to FIG. 4, a self-tapping or self-cutting screw is inserted as a fastening element 21 into the receiving opening 20 in the bearing pin 14. In both variants, in a pre-mounted state, the fastening element 21 is particularly preferably already received in the receiving opening 20 in the bearing pin 14 before the guide rail 8 with the cable pulley 13 latched or clipped onto the bearing pin 14 is mounted on the door inner part 2.

As can be seen in connection with FIG. 5, the structural part 4 of the door inner part 2 has a keyhole-like joining opening 23. This can be a bore or an elongate hole to compensate for tolerances. In the exemplary embodiment, the joining opening 23 is designed with a mounting opening 23a and with a mounting slot or longitudinal slot 23b adjoining or transitioning into it. The fastening element 21 bears with the screw head 21a thereof as a stop contour or bearing contour when joining the guide rail 8 to the door inner part 2 or to the structural part 4. The inner diameter of the mounting opening 23a or the clear width thereof is at least slightly larger than the diameter of the screw head 21a of the fastening element 21. The clear width of the longitudinal slot 21b of the joining opening 23 is slightly larger than or equal to the diameter of the threaded or screw shank 21b of the fastening element 21.

In the mounting position shown in FIG. 2 to 5, the fastening element 21 extends through the joining opening 23 of the structural part 4 of the door inner part 2. The screw head 21a of the fastening element 21 screwed in the bearing pin 14 via the screw shank 21b then bears thereagainst. In this way, the guide rail 8 is fastened in the region of the (lower) rail end 8a thereof to the door inner part 2 of the door assembly 1.

In summary, the invention relates to a door assembly 1 for a vehicle door of a motor vehicle, having a door inner part 2 and a guide rail 8 with a bearing pin 14, and having an annular cable pulley 13 for a pull cable 10 of a window regulator assembly 5, wherein the cable pulley 13 is snap fitted on the bearing pin 14 in a rotatably mounted manner, and wherein the bearing pin 14 has a receiving opening 19 for a fastening element 20 for joining the guide rail 8 to a structural part 4 of the door inner part 2.

The invention is not restricted to the exemplary embodiments described above. Rather, other variants of the invention can likewise be derived therefrom by a person skilled in the art without departing from the subject matter of the invention. All individual features described in connection with the exemplary embodiment can also be combined with one another in other ways without departing from the subject matter of the invention.

### LIST OF REFERENCE SIGNS

1 Door assembly

2 Door inner part/door shell

2a (Lateral) frame portion

2b Sill portion

2c (Lower) frame portion

3 Mounting region

4 Structural part/supporting structure/support

5 Window regulator assembly

6 Window frame

7 Window pane/side pane

8 Guide rail

8a (Lower) rail end

9 Rail slider

10 Pull cable

11 Actuator

12 Supporting structure

13 (Lower) cable pulley

14 Bearing pin

15 Ring body

15a Ring inner wall

15b Ring outer wall

16 Bearing opening

17 Running groove

18 Latching tongue

19 Latching groove

20 Receiving opening

21 Fastening element/screw

21a Screw head

21b Threaded shank

22 Screw sleeve/threaded sleeve

23 Joining opening

23a Mounting opening

23b Mounting slot/longitudinal slot

What is claimed is:

1. A door assembly for a vehicle door of a motor vehicle, having a door inner part and a guide rail with a bearing pin, and having an annular cable pulley for a pull cable of a window regulator assembly, wherein the cable pulley is snap fitted on the bearing pin in a rotatably mounted manner, and wherein the bearing pin has an in particular central receiving opening for a fastening element for joining the guide rail to a structural part of the door inner part.

2. The door assembly according to claim 1, wherein the guide rail is a plastics component with a molded-on bearing pin for the cable pulley, and/or wherein an actuator coupled to the cable pulley is attached to the guide rail.

3. The door assembly according to claim 1, wherein the fastening element is a screw head and a threaded shank with a self-tapping or metric external thread.

4. The door assembly according to claim 1, wherein a threaded sleeve, in particular with a metric internal thread, is inserted into the receiving opening in the bearing pin.

5. The door assembly according to claim 1, wherein the structural part of the door inner part has an in particular keyhole-like joining opening against which the fastening element bears when joining the guide rail to the structural part of the door inner part.

6. The door assembly according to claim 1, wherein in a pre-mounted state the fastening element is received in the receiving opening in the bearing pin.

7. The door assembly according to claim 1, wherein the cable pulley has a central bearing opening as well as a ring inner wall enclosing it, and a ring outer wall with a running groove for the pull cable.

8. The door assembly according to claim 1, wherein the cable pulley has a number of circumferentially distributed latching tongues and the bearing pin has an in particular encircling latching groove in which the latching tongues latch to produce the snap-fit connection.

9. A plastics guide rail for the door inner part of the door assembly according to claim 1, having a molded-on bearing pin with a cable pulley rotatably mounted thereon and fastened by latching or snap fitting, and with a receiving opening for a fastening element, in particular a screw with a screw head and with a threaded shank.

10. The door inner part comprising a guide rail according to claim 9.

11. The door assembly according to claim 2, wherein the fastening element is a screw head and a threaded shank with a self-tapping or metric external thread.

12. The door assembly according to claim 2, wherein a threaded sleeve, in particular with a metric internal thread, is inserted into the receiving opening in the bearing pin.

13. The door assembly according to claim 3, wherein a threaded sleeve, in particular with a metric internal thread, is inserted into the receiving opening in the bearing pin.

14. The door assembly according to claim 2, wherein the structural part of the door inner part has an in particular keyhole-like joining opening against which the fastening element bears when joining the guide rail to the structural part of the door inner part.

15. The door assembly according to claim 3, wherein the structural part of the door inner part has an in particular keyhole-like joining opening against which the fastening element bears when joining the guide rail to the structural part of the door inner part.

16. The door assembly according to claim 4, wherein the structural part of the door inner part has an in particular keyhole-like joining opening against which the fastening element bears when joining the guide rail to the structural part of the door inner part.

17. The door assembly according to claim 2, wherein in a pre-mounted state the fastening element is received in the receiving opening in the bearing pin.

18. The door assembly according to claim 3, wherein in a pre-mounted state the fastening element is received in the receiving opening in the bearing pin.

19. The door assembly according to claim 4, wherein in a pre-mounted state the fastening element is received in the receiving opening in the bearing pin.

20. The door assembly according to claim 5, wherein in a pre-mounted state the fastening element is received in the receiving opening in the bearing pin.
